(19) United States
(12) Patent Application Publication
(10) Pub. No.: US 2011/0271064 A1
(43) Pub. Date: Nov. 3, 2011

(54) STORAGE DEVICE AND METHOD FOR ACCESSING THE SAME

(75) Inventor: Zhiyuan Zhong, Shenzhen (CN)

(73) Assignee: NETAC TECHNOLOGY CO., LTD., Shenzhen (CN)

(21) Appl. No.: 13/092,224

(22) Filed: Apr. 22, 2011

(30) Foreign Application Priority Data
Apr. 29, 2010 (CN) 201010161799.4

(51) Int. Cl. G06F 12/00

(52) U.S. Cl. 711/154; 711/E12.001

(57) ABSTRACT

The present invention provides a storage device, which includes: a storage medium including a data address table, the data address table recording addresses for data stored in the storage medium; and a control module for receiving an external operation instruction and determining whether the operation instruction is an acceptable instruction, wherein if the operation instruction is the acceptable instruction, the control module determines an operation address corresponding to the operation instruction according to the data address table and executes the operation instruction in the storage medium according to the determined operation address, and if the operation instruction is not the acceptable instruction, the control module rejects the operation instruction.

### CROSS REFERENCE TO RELATED APPLICATION

This application claims the benefit of priority to Chinese Patent Application No. 201010161799.4, entitled “STORAGE DEVICE AND METHOD FOR ACCESSING THE SAME”, filed on Apr. 29, 2010 with State Intellectual Property Office of PRC, which is incorporated herein by reference in its entirety.

### FIELD OF THE INVENTION

The present invention relates to the field of file content protection, and particularly relates to a storage device and a method for accessing the same.

### BACKGROUND OF THE INVENTION

Usually, storage devices can not be used directly by operating system. Storage device only provides interfaces for reading and writing raw data, and there is no concept of “file” in the storage device. The reason why directories and files can be seen through the operating system is that a file system is written into the storage device by the operating system. The file system may contain root directories; the root directories may contain subdirectories; and the subdirectories may contain one or more files.

The operating system can find a subdirectory in a root directory, then find another subdirectory in the subdirectory, and proceed in the same way until find the required file. The above-mentioned structure is implemented in the storage device by reading data at an entry address (such as sector 0), at which subsequent entry addresses are recorded (for example, names and entry addresses of 10 subdirectories are recorded); each file and each directory are directed by several indexes, and the names of each file and each directory are saved in their parent directories; and there may also be an index list showing which sectors the actual file contents of the files are saved in. Therefore, a file system usually includes the following parts: a reserved area, a file directory area, an actual file content area, and a file index area. The reserved area records information concerning the file system itself. The file directory area records information concerning the files, including filenames, file attributes and the like. The actual file content area records the actual contents of the files. Items in the file index area are used as pointers to items in the file content area, indicating the storage location of the actual contents of the files.

With the above described technique in the prior art, file contents stored in the storage device are often played and duplicated illegally.

### SUMMARY OF THE INVENTION

According to an aspect of the present invention, a storage device is provided, the storage device including: a storage medium including a data address table, the data address table recording addresses for data stored in the storage medium; and a control module for receiving an external operation instruction and determining whether the operation instruction is an acceptable instruction, wherein if the operation instruction is the acceptable instruction, the control module determines an operation address corresponding to the operation instruction according to the data address table and executes the operation instruction in the storage medium according to the determined operation address, and if the operation instruction is not the acceptable instruction, the control module rejects the operation instruction.

According to another aspect of the present invention, a method for accessing a storage device is provided, the method including: configuring a data address table in the storage device, the data address table recording addresses for data in a storage medium of the storage device; receiving an external operation instruction; determining whether the operation instruction is an instruction acceptable to the storage device; and determining an operation address corresponding to the operation instruction according to the data address table if the operation instruction is the acceptable instruction and executing the operation instruction in the storage medium according to the determined operation address, rejecting the operation instruction if the operation instruction is not the acceptable instruction.

According to yet another aspect of the present invention, a storage device is provided, the storage device including: an unprotected data storage area; a protected data storage area; a boundary address table for recording a boundary address between the unprotected data storage area and the protected data storage area; and a control module for determining whether an external operation instruction is to access the unprotected data storage area or the protected data storage area, wherein if it is determined that the operation instruction is to access the unprotected data storage area, the unprotected data storage area is accessed by the operation instruction, and if it is determined that the operation instruction is not to access the unprotected data storage area, the control module further determines whether the operation instruction is an acceptable instruction, if the operation instruction is the acceptable instruction, the access is permitted, and if the operation instruction is not the acceptable instruction, the operation instruction is rejected.

### BRIEF DESCRIPTION OF THE DRAWINGS

FIG. 1 exemplarily shows a storage device according to an embodiment of the present invention;

FIG. 2 exemplarily shows struct information of a file according to an embodiment of the present invention;

FIG. 3 shows a flowchart for accessing the storage device according to an embodiment of the present invention;

FIG. 4 exemplarily shows a storage device according to another embodiment of the present invention; and

FIG. 5 exemplarily shows a directory structure to be saved according to an embodiment of the present invention.

### DETAILED DESCRIPTION OF THE INVENTION

In the following, embodiments of the present invention will be illustrated in details in conjunction with the drawings.

### 1. Embodiment 1

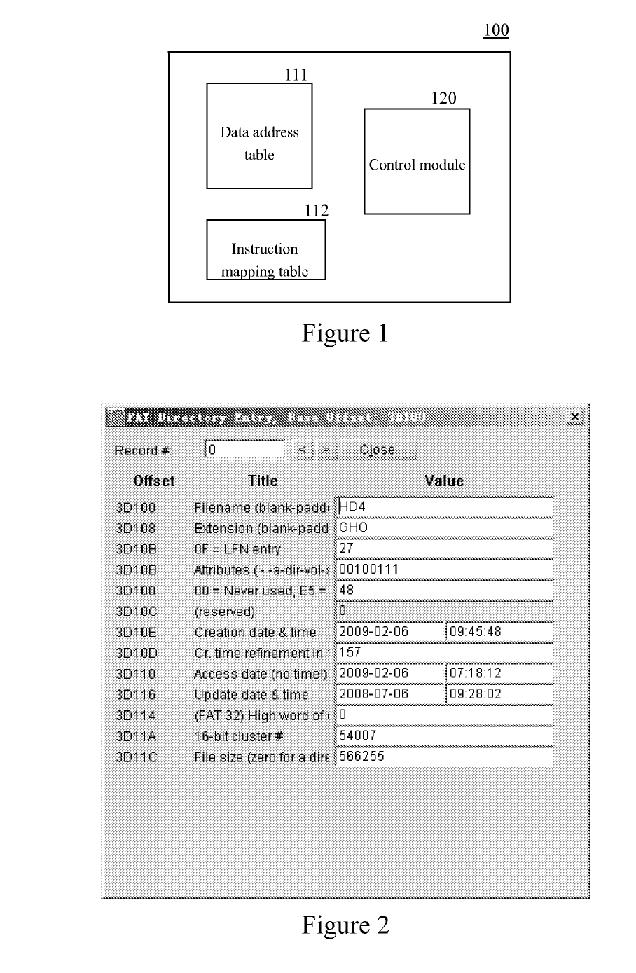

As shown in FIG. 1, a storage device 100 according to an embodiment of the present invention includes a data address table 111. When storing file contents into the storage device 100, respective sector addresses for saving respective files are recorded in the data address table 111. In the following, a process for creating the data address table according to an exemplary embodiment of the present invention will be described.

First, after file content is copied to the storage device 100, a struct of the file is obtained by analyzing the sector addresses occupied by the file content. Assuming that the storage device 100 adopts FAT file system, then the struct information of the file can be obtained by invoking an API function of the operating system. As shown in FIG. 2, the struct information includes a filename, a file size of the file and an entry address of the file content. Taking the filename HD4.GHO as an example, its corresponding file size is 566255 bytes, and a starting cluster of its file content is cluster No. 54007. Assuming that in this FAT file system each cluster has 4 sectors, and the cluster No. 2 (FAT dose not have cluster No. 0 and cluster No. 1, and data starts from cluster No. 2) starts from sector No. 520, then the cluster chain of the file starts from cluster No. 54007 and continues consecutively, occupying 27 clusters in all. Therefore, cluster No. 54007 to cluster No. 54033, which correspond to sector No. 216540 to sector No. 217644 when converted into sectors, constitute the content area of the file. In this way, the sectors occupied by the file content are known. Then a struct as following is created:

```
Struct
{
  DWORD startAddr;
  DWORD len;
};
```

where startAddr indicates a start address, and len indicates a length. Taking the above-described file as an example, startAddr=216540, and len=1105.

Each of the files stored in the storage device 100 is handled through the above-described process, and each of the created struct arrays is written into the data address table 111.

Referring back to FIG. 1, the storage device 100 further includes a control module 120. When an external operation instruction (such as a read instruction or a write instruction) accesses the storage device 100, the control module 120 may determine whether the operation instruction is an acceptable instruction, i.e. whether it is legal. If the control module 120 determines that the operation instruction is an illegal instruction, the control module 120 would not execute the instruction and would return error information, or the control module 120 would not response to the operation instruction. If the control module 120 determines that the operation instruction is an acceptable instruction, the control module 120 would accept the operation instruction, and would determine the operation address to which the operation instruction points according to the data address table 111, so as to execute the operation instruction.

According to an embodiment of the present invention, the storage device 100 further includes a file directory area and a file content area (not shown), in which the file directory area is used for saving information such as filenames, file attributes and the like, and the file content area is used for saving the actual contents of the files. In the data address table 111, the sector addresses occupied by the actual contents of the respective files are recorded, while the addresses of the information saved in the file directory area are not recorded. That is to say, the addresses of the information such as the filenames, the file attributes and the like are not recorded in the data address table 111. Thus, a user may browse the information such as the file directories, the filenames, the file attributes and the like in the storage device 100 simply by existing approach, without the use of the data address table 111. In other words, an illegal user can't access the data address table 111 and thus can't play or duplicate the protected file contents, but still can normally read the data in the reserved area and the file directory area of the storage device 100, such as the names, attributes of the files and the directories, and the like.

As described above, any external operation instruction may access the data address table 111 only when it is determined by the control module 120 as being “acceptable”, thereby protecting the address information saved in the data address table 111 from being acquired or tampered illegally by external operation instructions.

According to an embodiment of the present invention, the acceptable instruction refers to an instruction converted from a conventional machine instruction by using a predetermined algorithm. More specifically, the control module 120 only regards an instruction that has been converted with the predetermined algorithm as an acceptable instruction. When a user sends an operation instruction to the storage device 100 by utilizing an external device (for example, a host), only when the user has legally known the predetermined converting algorithm and has converted the conventional machine instruction with the predetermined algorithm before sending it to the storage device 100, the control module 120 may regard the operation instruction as an acceptable instruction. On the contrary, if the user is an illegal user, i.e. the user has no knowledge of the predetermined converting algorithm, and when the user sends the conventional machine instruction to the storage device 100, the control module 120 may regards the instruction as an unacceptable instruction, i.e. an illegal instruction.

According to an embodiment of the present invention, the storage device 100 may further include an instruction mapping table 112, in which one-to-one correspondence relationships between existing machine instructions Aᵢ and converted instructions Aᵢ′ that have been converted by the predetermined converting algorithm are recorded. According to the correspondence relationships of the instructions recorded in the instruction mapping table 112, the control module 120 may identify whether a received operation instruction is an instruction that has been converted by the predetermined algorithm, and may determine operation(s) to be executed by the instruction, so as to execute the operation(s), such as reading or writing, at corresponding address.

In use, a legal user has known the predetermined converting algorithm. For example, the legal user may use a particular driver containing the predetermined converting algorithm to convert the conventional machine instruction. When the user accesses the storage device 100 by a host installed with the particular driver, the driver intercepts the instruction sent to the storage device 100, converts the instruction with the predetermined algorithm, and then sends the instruction to the storage device 100, thus the file contents saved in the storage device 100 may be read or duplicated. In contrast, an illegal user is able to read or duplicate the file contents saved in the storage device 100 as he or she has no knowledge about the predetermined converting algorithm. According to another embodiment of the present invention, the driver may only convert operation instructions sent from some predetermined applications in the host with the predetermined algorithm, and sends operation instructions sent from other applications directly to the storage device 100 without performing the predetermined conversion. In this way, it is implemented that only predetermined applications are permitted to read or duplicate the file contents saved in the storage device 100.

There are many ways to convert operation instructions. For example, simply modifying a command code is feasible. Taking SCSI commands for example, it is feasible to convert the command code 0X28 of read command into a private command code (for example, 0XF8) according to a previous agreement between the control module 120 and the driver. Also the control module 120 may identify the command 0XF8 according to the previously agreed rules and return correct data. In this way, since an illegal user would invoke standard system file read command other than the command 0XF8, he or she would not obtain the correct data. Only an authorized user may send out the command 0XF8 by using the driver to convert the original command, and then read the correct data. There are alternatives for the instruction converting step. For example, the driver and the storage device 100 may agreed on a cryptographic-key, through which the address and the length to be read or written are encrypted with DES algorithm or AES algorithm and are then sent to the storage device 100. For example, assuming that one sector of data is to be read from sector No. 0 is to be read, and a standard read command is as follows:

28 00 00 00 00 00 00 00 01 00

However, the command to be sent can be encrypted with DES algorithm or AES algorithm or the like and turned into:

f8 aa bb cc dd ee ff 01 23 45

After the storage device receives the command, the control module performs decoding based on the instruction mapping relationship saved in the instruction mapping table 112 to obtain the original operation instruction to be executed, and then proceeds accordingly.

There are numerous solutions for converting instructions (including but not limited to DES encryption and AES encryption), which can be conceived by those skilled in the art and will not be enumerated herein.

### 2. Embodiment 2

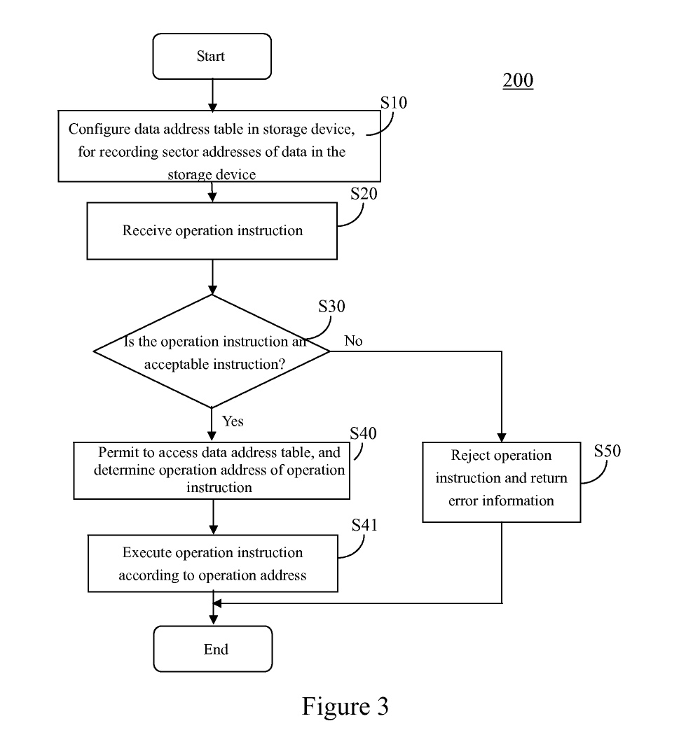

In the following, a storage device accessing method 200 according to another aspect of the present invention will be described with reference to FIG. 3. As shown in FIG. 3, in step S10, a data address table is created in the storage device 100, with the sector addresses of the files in the storage device 100 being recorded in the data address table. Then, in step S20, an external operation instruction is received by the control module of the storage device 100. After receiving the external operation instruction, the control module determines whether the instruction is an acceptable instruction (step S30). If the instruction is an acceptable instruction, it is permitted to access the data address table, in which the operation address pointed by the instruction is determined (step S40) to execute this instruction at the corresponding address (step S41). On the contrary, if the instruction is determined as an unacceptable instruction, the instruction is rejected and error information is returned, or no response to the instruction is made (step S50).

As mentioned above, the storage device 100 may include the file directory area and the file content area. In the data address table 111, the sector addresses occupied by the actual contents of respective files are recorded, while the addresses of the information saved in the file directory area, i.e. the addresses of the information such as the filenames, the file attributes and the like, are not recorded.

Furthermore, the acceptable instruction may be an instruction converted from a conventional machine instruction with a predetermined converting algorithm. That is to say, only the instruction that has been converted with the predetermined converting algorithm is regarded as an acceptable instruction by the control module 120. According to an embodiment of the present invention, the control module 120 may determine whether an external operation instruction is an acceptable instruction according to the instruction mapping table 112 as described above.

### 3. Embodiment 3

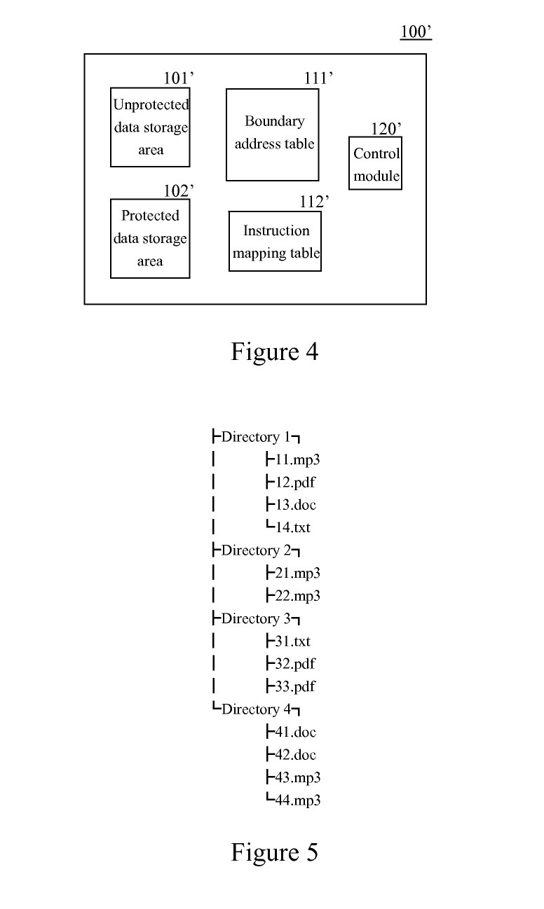

According to another embodiment of the present invention, a table of boundary addresses in the storage device 100 may be used as an alternative to the data address table. As shown in FIG. 4, a storage device 100′ includes an unprotected data storage area 101′ and a protected data storage area 102′. The unprotected data storage area 101′ is used for saving data accessible to any user, such as data in the reserved area and the file directory area, while the protected data storage area 102′ is used for saving data only accessible to legal users, such as data in the file content area. In the storage device 100′, a boundary address table 111′ is arranged, in which the boundary address between the unprotected data storage area and the protected data storage area is recorded. When an external operation instruction accesses the storage device 100′, the control module 120′ of the storage device 100′ determines whether the operation instruction is to access the unprotected data storage area 101′ or the protected data storage area 102′ according to the boundary address recorded in the boundary address table 111′. If it is determined that the operation instruction is to access the unprotected data storage area 101′, the access is permitted. On the contrary, if it is determined that the operation instruction is to access the protected data storage area 102′, it is further determined whether the operation instruction is an acceptable instruction. If the operation instruction is an acceptable instruction, the access is permitted; and if not, the execution of the operation instruction is rejected.

Thus, the protection to the file contents may be realized simply by recording the boundary address between the unprotected data storage area 101′ and the protected data storage area 102′. For example, assuming that the unprotected data storage area 101′ resides before the address 1000 and the protected data storage area 102′ resides after address 1000, then the boundary address is the address 1000. In this way, the determination regarding to the operation instruction will be very simple and efficient.

In the present embodiment, as mentioned above, the acceptable instruction may be an instruction converted from a conventional machine instruction with a predetermined converting algorithm. That is to say, only the instruction that has been converted with the predetermined converting algorithm is regarded as an acceptable instruction by the control module 120′. Furthermore, the control module 120′ may also determine whether an external operation instruction is an acceptable instruction according to the instruction mapping table as mentioned above (for example, the instruction mapping table 112′ as shown in FIG. 4).

In the following, the storage device containing the boundary address table will be described in more details in conjunction with specific embodiments. Originally, the storage device 100′ has been formatted. Taking FAT file system as an example, at this point of time the file system of the storage device 100′ is empty without any file or any directory, and all the clusters are empty. First, a file structure, which is same as the preset file directory structure to be saved, is to be created in the storage device. For example, the directory structure to be saved is as shown in FIG. 5. Referring to FIG. 5, the directory structure to be saved is comprised of four directories, where the first directory includes one mp3 file, one pdf file, one doc file, and one txt file; the second directory includes two mp3 files; the third directory includes one txt file and two pdf files; and the fourth directory includes two doc files and two mp3 files. First, the first directory is to be created in the empty file system (both the directory and the files can be created by invoking API functions of the operating system, which will not be described in details herein). When creating the directory, the operating system will assign some clusters to the directory to serve as the space for the directory. After the directory is created, the file is started to be created by creating an empty file without writing file contents into the file, i.e. the created file has a filename and various attributes and has a file size of 0. Thus, the operating system will not assign any cluster to this file, but just record the attributes of the file (including the file size and the like) in an information area of the parent directory of the file. All of the directories and files are to be created sequentially one after another, and all the files are ensured to be empty, i.e. the file size is 0 byte. During the process, whenever a new cluster is required, the operating system will always take the first one of the free clusters for using. In this way, after the creation of all the directories and file structures, just the first several clusters are occupied while the subsequent clusters are empty, and the first several clusters are all occupied by directories. By now, any user, no matter legal or illegal, may see all the directories and all the files when accessing the storage device. However, none of the files can be played or duplicated due to the file size of 0.

Next, data is to be written into the files. When starting to write the data of the first file, the first cluster of the file is recorded and the corresponding sector is calculated. The calculated corresponding sector is defined as the boundary between the unprotected data storage area 101′ and the protected data storage area 102′, and the address of the calculated sector is recorded into the boundary address table 111′ as the boundary address. Accordingly, the area previous to the sector is the unprotected data storage area 101′, and the area following the sector is the protected data storage area 102′. Then file contents are sequentially written into the protected data storage area 102′ of the storage device 100′. The operating system consecutively assigns subsequent clusters while keeps the clusters previously assigned to the directories unchanged. In this way, the amount of data to be recorded in the boundary address table 111′ is small, and it is also simple for the control module 120′ of the storage device 100′ to distinguish the unprotected data storage area 101′ from the protected data storage area 102′.

It is to be understood that the file content area according to the present invention may be divided into the protected area and the unprotected area. Thus, file contents needing protection may be stored in the protected area, and file contents needing no protection may be stored in the unprotected area. A user may access the file contents in the protected area in the same way as described in the above embodiments for accessing the file protected area, and may access the file contents in the unprotected area in the same way as in the prior art.

Although the preferred embodiments of the present invention are described above in details, the present invention is not limited thereto, and numerous modifications and variations that are apparent to those skilled in the art still fall within the scope of the present invention.

1. A storage device comprising:
a storage medium including a data address table, the data address table recording addresses for data stored in the storage medium; and
a control module for receiving an external operation instruction and determining whether the operation instruction is an acceptable instruction, wherein if the operation instruction is the acceptable instruction, the control module determines an operation address corresponding to the operation instruction according to the data address table and executes the operation instruction in the storage medium according to the determined operation address, and if the operation instruction is not the acceptable instruction, the control module rejects the operation instruction.

2. The storage device according to claim 1, wherein if the operation instruction is an instruction converted with a predetermined algorithm, the control module determines that the operation instruction is the acceptable instruction.

3. The storage device according to claim 2, wherein the storage medium further includes an instruction mapping table, the instruction mapping table recording a correspondence relationship between an original instruction and the instruction converted with the predetermined algorithm, and
the control module determines an operation to be executed by the received operation instruction according to the correspondence relationship recorded in the instruction mapping table.

4. The storage device according to claim 1, wherein the storage medium further comprises:
a file content area for storing actual contents of files, wherein the data address table stores addresses for saving the files in the file content area,
wherein the control module is adapted for determining whether the operation instruction to access the file content area is the acceptable instruction.

5. A method for accessing a storage device, comprising:
configuring a data address table in the storage device, the data address table recording addresses for data in a storage medium of the storage device;
receiving an external operation instruction;
determining whether the operation instruction is an instruction acceptable to the storage device; and
determining an operation address corresponding to the operation instruction according to the data address table if the operation instruction is the acceptable instruction and executing the operation instruction in the storage medium according to the determined operation address, or rejecting the operation instruction if the operation instruction is not the acceptable instruction.

6. The method for accessing the storage device according to claim 5, wherein the step of determining whether the operation instruction is the acceptable instruction further comprises: determining that the operation instruction is the acceptable instruction if the operation instruction is an instruction converted with a predetermined algorithm.

7. The method for accessing the storage device according to claim 6, further comprising a step of configuring an instruction mapping table in the storage medium, the instruction mapping table recording a correspondence relationship between an original instruction and the instruction converted with the predetermined algorithm,
wherein the step of executing the operation instruction in the storage medium further comprises: determining an operation to be executed by the operation instruction according to the correspondence relationship recorded in the instruction mapping table.

8. The method for accessing the storage device according to claim 5, wherein the storage device comprises a file content area for storing actual contents of files, and the method further comprises: before determining whether the operation instruction is the acceptable instruction, determining whether the operation instruction is to accesses the file content area; if the operation instruction is to accesses the file content area, proceeding to determine whether the operation instruction is the acceptable instruction, and if the operation instruction is not to accesses the file content area, executing the operation instruction directly.

9. A storage device comprising:
an unprotected data storage area;
a protected data storage area;
a boundary address table for recording a boundary address between the unprotected data storage area and the protected data storage area; and
a control module for determining whether an external operation instruction is to access the unprotected data storage area or the protected data storage area,
wherein if it is determined that the operation instruction is to access the unprotected data storage area, the unprotected data storage area is accessed by the operation instruction, and if the operation instruction is not to access the unprotected data storage area, the control module further determines whether the operation instruction is an acceptable instruction, if the operation instruction is the acceptable instruction, the access is permitted, and if the operation instruction is not the acceptable instruction, the operation instruction is rejected.

10. The storage device according to claim 9, wherein if the operation instruction is an instruction converted with a predetermined algorithm, the control module determines that the operation instruction is the acceptable instruction.

11. The storage device according to claim 10, wherein the storage medium further comprises an instruction mapping table, the instruction mapping table recording a correspondence relationship between an original instruction and the instruction converted with the predetermined algorithm, and
the control module determines an operation to be executed by the operation instruction according to the correspondence relationship recorded in the instruction mapping table.
